(19) United States
(12) Patent Application Publication
(10) Pub. No.: US 2009/0263180 A1
(43) Pub. Date: Oct. 22, 2009

(54) DEVICE FOR SECURING AN ADD-ON AND A SUPPORT IN SPACED-APART RELATION

(75) Inventor: Vincent De Gelis, Grenoble (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/721,890

(22) PCT Filed: Oct. 27, 2005
(86) PCT No.: PCT/EP2005/011506

§ 371 Date: Oct. 24, 2007

(30) Foreign Application Priority Data
Dec. 18, 2004 (DE) 10 2004 061 087.8

(51) Int. Cl. F16B 37/04

(52) U.S. Cl. 403/22

(57) ABSTRACT

The invention relates to a device for fastening an add-on (21) and a support (20) at a distance from each other, comprising a plastic mounting nut (1), a plastic compensating bush (5) and a fastening screw (14) having a screw shank (15) from a hard material. A threaded arrangement (8, 9) having a first direction of thread is configured between the mounting nut (1) and the compensating bush (5). The screw shank (15) has an external thread (17) having a second direction of thread opposite the first direction of thread which is used to produce an internal thread in a channel section (12) configured in the compensating bush (5). When the fastening screw (14) is screwed in, the compensating bush (5) is automatically screwed out from the mounting nut (1).

### BACKGROUND OF THE INVENTION

1. Field of the Invention

The present invention relates to a device according to a mounting device including a compensating bush.

2. Description of the Related Art

Such a device is known from U.S. Pat. No. 6,357,953 B1. The device of the type in question for securing an add-on and a support in spaced-apart relation is provided with a mounting nut that is fixedly connectable to the support and has an internal thread of a first thread direction, and is configured with a compensating bush having an external thread mating with the internal thread of the mounting nut. The compensating bush is able to be screwed into the mounting nut. Also present is a securing screw that is operative to connect the add-on to the compensating bush and possesses a screw shank made of a hard material, said screw shank being configured with an external thread of a second thread direction opposite to the first thread direction and being insertable in a screw channel made to extend through the mounting nut and into the compensating bush. The compensating bush is made of a soft material compared to the screw shank, and has a channel section that forms part of the screw channel and whose inner diameter is smaller than the outer diameter of the screw shank, such that an internal thread can be formed in the channel section of the compensating bush by means of the external thread of the screw shank of the securing screw.

Known from DE 201 19 112 U1 is a device provided with a mounting nut that is fixedly connectable to a support. The mounting nut is configured, in a first section, with an internal thread of a first thread direction, and, in a second section, with a second internal thread of a second thread direction opposite to the first thread direction. The device of the type in question further comprises a compensating bush, which is provided with the first thread direction by an external thread configured as complementary to the first internal thread of the mounting nut, such that the compensating bush can be screwed into the first internal thread of the mounting nut. The compensating bush is configured with a drive means at its end pointing away from the mounting nut, to cause the compensating bush to protrude past the mounting nut by a set length in the axial direction. Finally, to secure an add-on to the compensating bush, there is a securing screw that can be screwed through a screw channel of the compensating bush engagingly into the second internal thread of the mounting nut by means of a screw shank provided with an external thread of the second thread direction and configured as complementary to the second internal thread of the mounting nut. Although this device does enable a support and an add-on to be connected to each other with a given mutual spacing, for example one that effects tolerance compensation, its handling and in particular the need to unscrew the compensating bush in a separate step have proven somewhat laborious in certain applications.

### SUMMARY OF THE INVENTION

The object underlying the invention is to specify a device of the initially cited kind that is distinguished by a bush body stably accommodated in the mounting nut.

This object is achieved according to the invention as disclosed hereafter.

By virtue of the engagement of the collar configured on the mounting nut and the collar recess configured on the compensating bush, an appreciable stabilizing effect is achieved with the inventive device.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective representation of a mounting nut and a compensating bush protruding beyond the mounting nut in an exemplary embodiment of a device according to the invention;

FIG. 2 is a longitudinal section of the exemplary embodiment according to FIG. 1 in a preassembled position, in which the compensating bush is screwed all the way into the mounting nut and a securing screw is poised in the compensating bush; and

FIG. 3 is a longitudinal section of the exemplary embodiment according to FIG. 1 and FIG. 2 in a final assembled position, in which the securing screw is screwed into both the compensating bush and the mounting nut.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

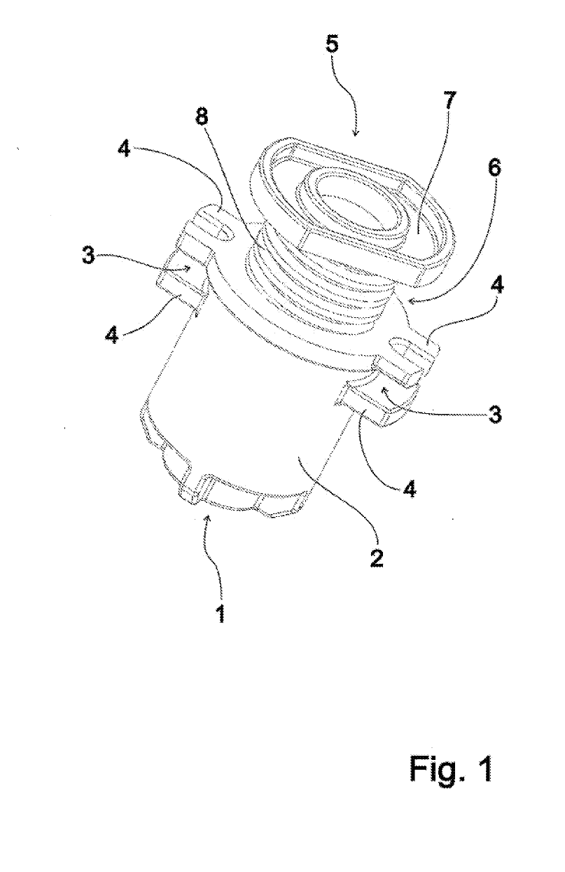

FIG. 1 is a perspective representation of an exemplary embodiment of a device according to the invention, comprising a mounting nut 1 with a substantially cylindrical, plastic nut body 2. Configured on the outside of nut body 2 are a number of radially outwardly projecting bearing protrusions 4, which are disposed opposite each other in pairs on both sides of clearances 3.

Further depicted in FIG. 1 is a compensating bush 5, which projects beyond mounting nut 1 and which is configured with an also substantially cylindrical, plastic bush body 6 and a bearing plate 7 formed onto one end of the bush body 6 and projecting radially beyond said bush body 6. Configured on the outside of bush body 6 is an external thread 8 having a first thread direction.

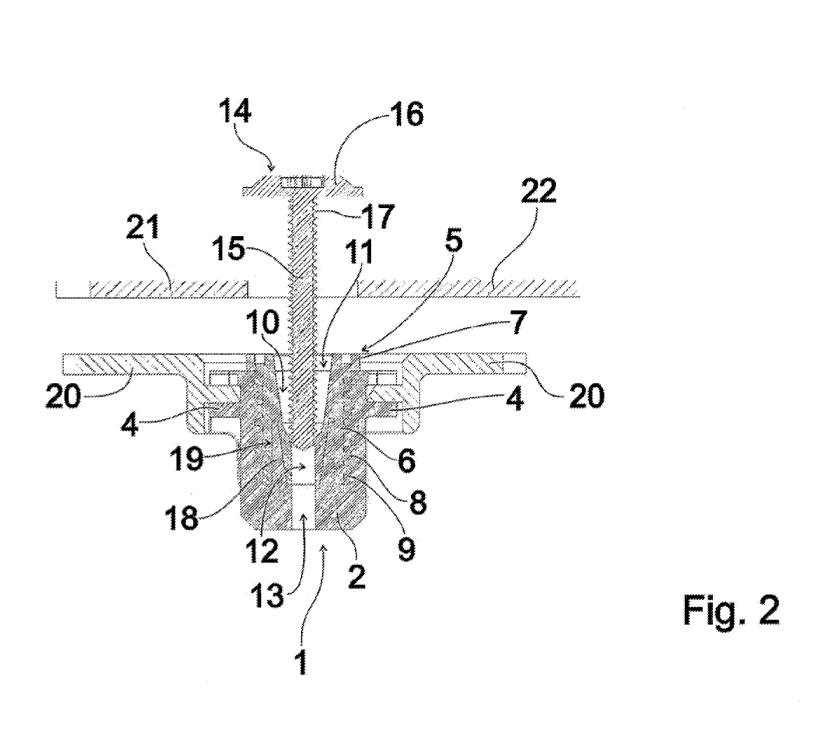

FIG. 2 is a longitudinal section of the exemplary embodiment according to FIG. 1 in a preassembled position, in which the compensating bush 5 is screwed by its external thread 8 all the way into an internal thread 9 of mounting nut 1 that is configured on the inside of nut body 2 with the first thread direction and complementarily to the external thread 8 of bush body 6.

It can be seen from FIG. 2 that the device is configured with a screw channel 10, which extends axially through the bush body 6 of compensating bush 5, and which, in its region facing bearing plate 7, comprises a lead-in section 11 tapered in a funnel shape and pointing away from bearing plate 2, and, adjacent said lead-in section 11, a cylindrical, smooth-walled, first channel section 12.

It can further be appreciated from FIG. 2 that, in prolongation of first channel section 12, screw channel 10 is extended into mounting nut 3 by a second channel section 13, which is configured in the nut body 2 and which for ease of production is also cylindrical and smooth-walled in this exemplary embodiment, and is therefore open at both ends in the exemplary embodiment shown.

Finally, it can be appreciated from FIG. 2 that the inventive device comprises a securing screw 14 with a screw shank 15 and a screw head 16, the screw shank 15 being configured with an external thread 17 having a second thread direction opposite to the first thread direction of the thread arrangement configured between mounting nut 1 and compensating bush 5. The securing screw 14 is made of a harder material than mounting nut 1 and compensating bush 5, for example a metal. The outer diameter of the screw shank 15 of securing screw 14 is larger than the inner diameter of both first channel section 12 and second channel section 13. In the arrangement illustrated in FIG. 2, the screw shank 15 of securing screw 14 is poised to enter first channel section 12.

In the illustrated and described exemplary embodiment of a device according to the invention, configured in the nut body 2 is a collar 18 that extends axially away from second channel section 13 and which in the arrangement of FIG. 2 engages stabilizingly in a complementary collar recess 19 configured in bush body 6.

In the preassembled position of the inventive device, as illustrated in FIG. 2, the mounting nut 1 is inserted by its nut body 2 in a recess of a support 20, the rim of which recess engages in the clearances 3 configured between bearing protrusions 4. The rotationally fixed connection between mounting nut 1 and support 20 is preferably created by force-locking and/or form-locking.

In the preassembled position shown in FIG. 2, securing screw 14 is guided through a recess provided in an add-on 21 that is to be spacedly connected to the support 20, screw head 16 being disposed at a distance from add-on 21.

At the beginning of the securing process, securing screw 14 is rotated in the second thread direction of external thread 17, thereby forming an internal thread in first channel section 12. As soon as the resistance to the formation of the internal thread in first channel section 12 is greater than the frictional resistance between the external thread 8 of compensating bush 5 and the internal thread 9 of mounting nut 1, compensating bush 5 automatically rotates out of mounting nut 1 until bearing plate 7 butts against the side of add-on 21 facing away from support 20 and further axial movement of compensating bush 5 is prevented. The process of forming an internal thread in first channel section 12 then continues.

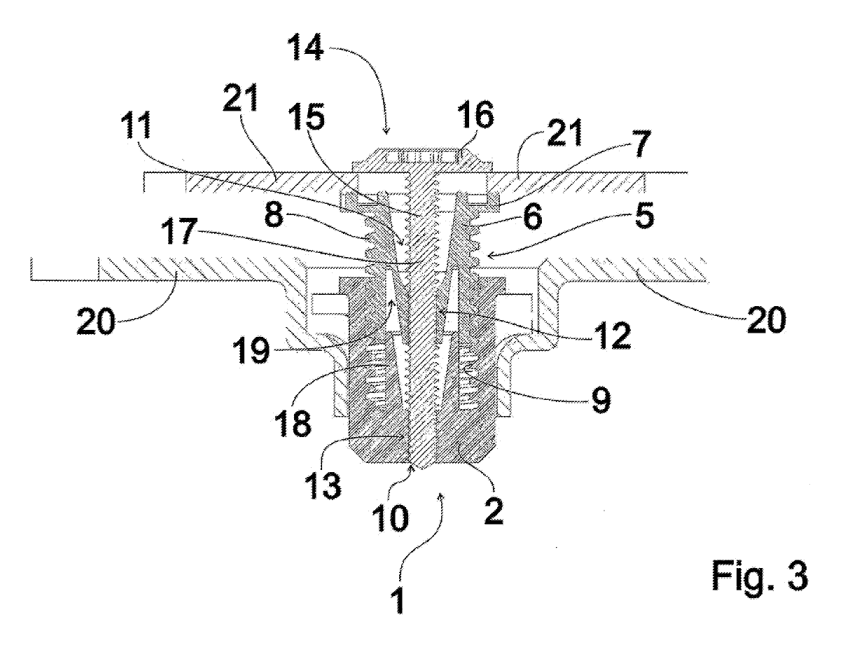

FIG. 3 is a longitudinal section of the exemplary embodiment according to FIG. 1 and FIG. 2 in a final assembled position, in which securing screw 14 is screwed into both the first channel section 12, configured in compensating bush 5, and the second channel section 13, configured in mounting nut 1, also thereby forming an additional internal thread. In the final assembled position, collar 18 is still stabilizingly engaged with collar recess 19. This secures compensating bush 5 against rotation, and add-on-part 21 is disposed at a fixed distance from the support 20 and is connected thereto.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-5. (canceled)

6. A device for securing an add-on (21) to a support (20) in spaced-apart relation, said device comprising;
a mounting nut (1) that is fixedly connectable to said support (20) and has an internal thread (9) of a first thread direction, said mounting nut also having a screw channel (10) extending therethrough;
a plastic compensating bush (5) having an external thread (8) mating with said internal thread (9) of said mounting nut (1) whereby said compensating bush (5) can be screwed into said mounting nut (1), said compensating bush (5) further including a channel section (12) aligned with said screw channel (10);
a securing screw (14) operative to connect said add-on (21) to said compensating bush (5), said securing screw (14) including a screw shank (15) with an external thread (17) of a second thread direction opposite to said first thread direction, said screw shank being insertable into said screw channel (10) and into said compensating bush (5), said securing screw (14) made of a harder material than said compensating bush (5) and said screw shank (15) having an outer diameter which is larger than the inner diameter of said channel section (12), such that an internal thread can be formed in said channel section (12) by means of said external thread (17) of said screw shank (15); and
said mounting nut (1) configured with a collar (18) that projects axially from channel section (12) into the region of said internal thread (9) and which, in the screwed-together arrangement of said mounting nut (1) and said compensating bush (5), said collar (18) is in engagement with a collar recess (19) which is complementarily configured in said compensating bush (5).

7. The device of claim 1, wherein said mounting nut (1) and said compensating bush (5) are made of a softer material than said screw shank (15), said mounting nut (1) comprising a channel section (13) that defines a portion of said screw channel (10) and whose inner diameter is smaller than the outer diameter of said screw shank (15), such that an internal thread can be formed in said channel section (13) of said mounting nut (1) by means of said external thread (17) of said screw shank (15) of said securing screw (14).

8. The device of claim 2, wherein said channel sections (12, 13) are smooth-walled.

9. The device of claim 1, wherein the end of said compensating bush (5) includes a bearing plate (7) that projects, radially beyond said external thread (8) of said compensating bush (5).

10. The device of claim 1, wherein said mounting nut includes a radially outwardly projecting bearing protrusion (4).
